(19) United States
(12) Patent Application Publication
(10) Pub. No.: US 2017/0093196 A1
(43) Pub. Date: Mar. 30, 2017

(54) Rechargeable Battery Induction System and Methods of Making and Using the Same

(71) Applicant: Angel 7 Industries, LLC, San Antonio, TX (US)

(72) Inventor: Kerry S. Harris, San Antonio, TX (US)

(21) Appl. No.: 14/863,676

(22) Filed: Sep. 24, 2015

(51) Int. Cl. H02J 7/02; H02J 7/00

(52) U.S. Cl. CPC H02J 7/025; H02J 7/027; H02J 7/0042

(57) ABSTRACT

The present invention relates to a rechargeable battery induction system. Specifically, an induction receiver, otherwise known as an induction coil, is connected to contact points of a rechargeable battery and utilized in an electric device requiring battery power. The induction receiver may thus be disposed within electric device housing or case, and may further include protective circuitry to prevent damage to the induction receiver when the battery is charged through a cord, plug or via other means. Methods of making and using the same are further provided.

### TECHNICAL FIELD

The present invention relates to a rechargeable battery induction system. Specifically, an induction receiver, otherwise known as an induction coil or induction receiver coil, is connected to contact points of a rechargeable battery and utilized in an electric device requiring battery power. The induction receiver may thus be disposed within an electric device housing or case, and may further include protective circuitry to prevent damage to the induction receiver when the battery is charged through a cord, plug or via other means. Methods of making and using the same are further provided.

### BACKGROUND

Many electrical devices utilize battery technology to provide power when used. Of course, batteries only provide a certain amount of power before the battery is depleted requiring either replacement or recharging. Oftentimes, a battery is recharged by introducing electricity, typically from wall outlets, into the battery. The electricity causes the battery to charge so that the battery may be reused to power the electrical device. Typically, a power cord is utilized to plug the battery into a wall outlet, and the power cord may be directly electrically connected to the battery. Oftentimes, batteries are removable from electric devices and placed directly on electrical contacts of a charging base, with the charging base directly connected to a wall outlet.

Recharging of batteries may also be accomplished through the use of inductive charging. Inductive charging (also known as “wireless charging”) uses an electromagnetic field to transfer energy between two objects. This is usually done with a charging station. Energy is sent through an inductive coupling coil to an electrical device having an inductive receiving coil, which can then use that energy to charge batteries or run the device. Induction chargers typically use an induction coil to create an alternating electromagnetic field from within a charging base station, and further use a second induction coil or receiver in or attached to the electrical device to take power from the electromagnetic field and convert it back into electric current to charge the battery.

Inductive charging has several advantages. Charging is accomplished even with distance between the inductive coils, and can occur through cases or housings. Therefore, battery connections or contacts can be protected by preventing their exposure to the environment, reducing corrosion and damage. For example, electrical devices may be completely sealed if inductive charging is used, allowing electrical devices to be utilized in environments that were limiting prior, such as underwater or in other harsh environments.

Because the inductive coils may be protected within cases or housings, they typically have significantly less wear and tear, and last longer than direct electrical connections. Moreover, because no wires or cables are utilized for directly electrical connections, users do not have to worry about losing charging cables.

In many cases, induction coils are utilized directly as part of the circuitry of an electrical device itself, and the induction coils often are separate from the batteries themselves. However, for these electrical devices, the ability to utilize inductive charging is therefore manufactured into the device itself. Therefore, many electrical devices cannot obtain the advantages of inductive charging because the electrical devices are not manufactured in that manner.

Some electrical devices may be retrofit with induction coils to allow the electrical devices to charge inductively. However, these systems require either complicated techniques to incorporate the induction coils into the electrical devices after manufacture, or utilize the electrical devices charging ports to add the induction coils, which may then reside outside the housing of the electrical device. These retrofit induction coils may therefore be unprotected and subject to damage. While induction coils may be disposed on the electrical devices themselves and protected by a case, they may still be prone to damage and corrosion due to exposure to harsh environments. A need, therefore, exists for adding inductive charging to electrical devices. Specifically, a need exists for incorporating inductive charging into an electrical device without exposing internal circuitry of the electrical device. Moreover, a need exists for incorporating inductive charging into an electrical device without requiring exposure of the induction coils outside of the electrical device housing, thereby minimizing or eliminating corrosion or damage to the induction coils.

Specifically, a need exists for a rechargeable battery induction system that provides direct connection of the induction coil or receiver to a rechargeable battery. More specifically, a need exists for a rechargeable battery induction system having protective circuitry associated with the induction coils or receivers to prevent damage caused by electricity utilized to charge the battery from traditional charging methods, such as through power cords or other like charging methods.

In addition, a need exists for a rechargeable battery induction system that may be utilized with any electrical device having a rechargeable battery. Moreover, a need exists for a rechargeable battery induction system that may easily provide inductive charging capabilities to electrical devices not otherwise built with inductive coils or receivers.

### SUMMARY OF THE INVENTION

The present invention relates to a rechargeable battery induction system. Specifically, an induction receiver, otherwise known as an induction coil or induction receiver coil, is connected to contact points of a rechargeable battery and utilized in an electric device requiring battery power. The induction receiver may thus be disposed within an electric device housing or case, and may further include protective circuitry to prevent damage to the induction receiver when the battery is charged through a cord, plug or via other means. Methods of making and using the same are further provided.

To this end, in an embodiment of the present invention, a rechargeable battery for an electrical device is provided. The rechargeable battery comprises: a housing for the battery, wherein the housing comprises contacts configured to supply power to an electrical device and to receive power from a power source for charging the battery; an induction receiver coil electrically connected to the contacts for supplying power from an induction charging coil when disposed in proximity to the induction charging coil; and a protective circuit disposed between the induction receiver coil and the contacts, wherein the protective circuit is configured to protect the induction receiver from electricity from the battery and from another power source.

In an embodiment, the protective circuit is configured to allow electricity to flow from the induction receiver coil to the contacts.

In an embodiment, the protective circuitry is configured to prevent electricity from flowing from the contacts to the induction receiver coil.

In an embodiment, the protective circuit is configured to allow electricity to flow from the induction receiver coil to the contacts and to prevent electricity from flowing from the contacts to the induction receiver coil.

In an embodiment, the rechargeable battery further comprises: a protective housing disposed around the battery and covering the induction receiver coil.

In an embodiment, the induction receiver coil is adhered to the surface of the battery.

In an embodiment, the induction receiver coil and the protective circuit are disposed flat against the surface of the battery and configured to not interfere with the battery when it is disposed within an electrical device.

In an alternate embodiment, the present invention is an electrical device comprising the rechargeable battery.

In an embodiment, the electrical device is a mobile smart device.

In an embodiment, the battery is disposed within a slot and covered with a removable cover.

In an embodiment, the battery is disposed within a slot and sealed within the electrical device, and further configured to be sealed from environmental contaminants.

In an alternate embodiment of the present invention, a method of making a rechargeable battery induction system is provided. The method comprises the steps of: providing a rechargeable battery configured to power an electrical device, wherein the rechargeable battery comprises contacts configured to power the electrical device and to receive electricity for charging thereof; providing an induction receiver coil with protective circuitry; electrically connecting the induction receiver coil to the contacts of the rechargeable battery such that the protective circuitry is positioned between the induction receiver coil and the contacts of the battery, wherein the protective circuitry is configured to allow electricity to flow from the induction receiver coil to the contacts of the battery and to further prevent electricity from flowing from the contacts of the battery to the induction receiver coil.

In an embodiment, the method further comprises the step of: inserting the rechargeable battery, the induction receiver coil and the protective circuitry into an electrical device to power the same.

In an embodiment, the method further comprises the step of: adhering the induction receiver coil onto a surface of the battery.

In an embodiment, the method further comprises the step of: adhering the induction receiving coil and the protective circuitry onto a surface of the battery.

In an embodiment, the method further comprises the step of: covering the battery, the induction receiver coil, and the protective circuitry with a protective cover.

In an embodiment, the method further comprises the steps of: installing the rechargeable battery with the induction receiver coil and the protective circuitry into an electrical device; and charging the rechargeable battery by placing the electrical device in proximity to an induction charging coil.

In an embodiment, the method further comprises the step of: charging the rechargeable battery by plugging the electrical device into a wall outlet, wherein the protective circuitry prevents electricity from flowing from the wall outlet into the induction receiver coil.

In an embodiment, the method further comprises the step of: removing the battery from the electrical device and placing the battery onto a charging base in electrical contact with the contacts of the battery, wherein the protective circuitry prevents electricity from flowing from the charging base into the induction receiver coil.

In an embodiment, the method further comprises the step of: sealing the battery within the electrical device so that the electrical device is configured to prevent environmental contamination of the battery when exposed to harsh environmental conditions.

It is, therefore, an advantage and objective of the present invention to provide systems and methods for adding inductive charging to electrical devices.

Specifically, it is an advantage and objective of the present invention to provide systems and methods for incorporating inductive charging into an electrical device without exposing internal circuitry of the electrical device.

Moreover, it is an advantage and objective of the present invention to provide systems and methods for incorporating inductive charging into an electrical device without requiring exposure of the induction coils outside of the electrical device housing, thereby minimizing or eliminating corrosion or damage to the inductive coils.

Specifically, it is an advantage and objective of the present invention to provide a rechargeable battery induction system that provides direct connection of the induction coil or receiver to a rechargeable battery.

More specifically, it is an advantage and objective of the present invention to provide a rechargeable battery induction system having protective circuitry associated with the induction coils or receivers to prevent damage caused by electricity utilized to charge the battery from traditional charging methods, such as through power cords or other like charging methods.

In addition, it is an advantage and objective of the present invention to provide a rechargeable battery induction system that may be utilized with any electrical device having a rechargeable battery.

Moreover, it is an advantage and objective of the present invention to provide a rechargeable battery induction system that may easily provide inductive charging capabilities to electrical devices not otherwise built with inductive coils or receivers.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a prior art mobile smart phone having a charging cord that is plugged into a wall outlet.

FIG. 2 illustrates a prior art battery pack for an electrical device.

FIG. 3 illustrates a rechargeable battery for an electrical device comprising an induction receiver coil and protective circuitry in an embodiment of the present invention.

FIG. 4 illustrates a rechargeable battery for an electrical device comprising an induction receiver coil and protective circuitry within a cut-away housing in an embodiment of the present invention.

FIG. 5 illustrates a mobile smart phone having a slot for a rechargeable battery having an induction receiver coil and protective circuitry in an embodiment of the present invention.

FIG. 6 illustrates a mobile smart phone within which is placed a rechargeable battery having an induction receiver coil and protective circuitry in an embodiment of the present invention.

### DETAILED DESCRIPTION OF THE PRESENTLY PREFERRED EMBODIMENTS

The present invention relates to a rechargeable battery induction system. Specifically, an induction receiver, otherwise known as an induction coil or induction receiver coil, is connected to contact points of a rechargeable battery and utilized in an electric device requiring battery power. The induction receiver may thus be disposed within an electric device housing or case, and may further include protective circuitry to prevent damage to the induction receiver when the battery is charged through a cord, plug or via other means. Methods of making and using the same are further provided.

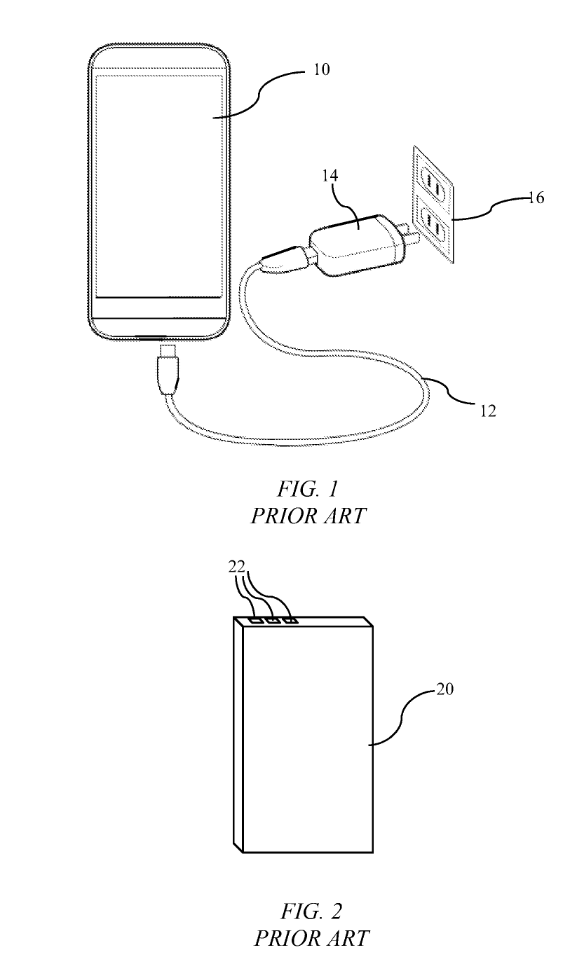

Now referring to the figures, wherein like numerals refer to like parts, FIG. 1 illustrates a prior art mobile smart phone 10 that may include a charging cord 12 and plug 14 that may be utilized to plug into a wall outlet 16 for charging of a rechargeable battery that may be disposed within the mobile smart phone 10 to provide power to the same without requiring the mobile smart phone 10 to remain plugged into the wall outlet to utilize the same. The mobile smart phone 10 is presented herein but it should be noted that any electrical device utilizing battery power may be utilized in the manner presented herein, and especially those electrical devices utilizing rechargeable batteries. A representation of a rechargeable battery 20, similar to one that may be utilized in a mobile smart phone 10 or any other electrical device, is illustrated in FIG. 2, although any rechargeable battery may be utilized as described herein. The rechargeable battery 20 may include a plurality of contacts 22 that may be utilized to allow the electrical device to draw power from the rechargeable battery 20. Typically, a rechargeable battery is contained within a space or slot within an electrical device for use of the same, wherein the space or slot may have mating contacts to engage the contacts 22 of the rechargeable battery 20.

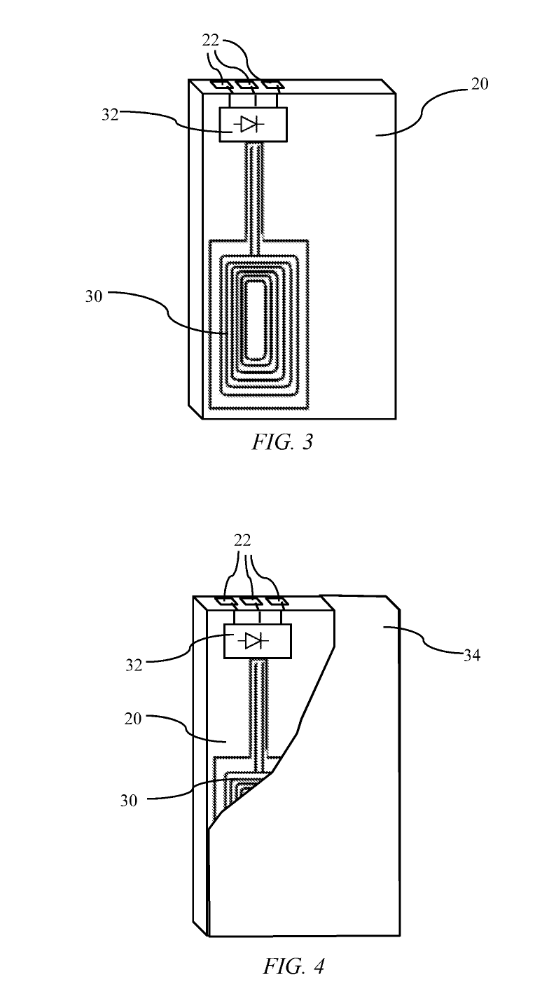

FIG. 3 illustrates rechargeable battery 20 with the plurality of contacts 22 having an induction receiver coil 30 disposed thereon in an embodiment of the present invention. The induction receiver coil 30 may preferably be disposed on a surface of the battery 20, and held to the surface with adhesive or other adhering means.

The induction receiver coil may have protective circuitry 32, represented by a diode symbol in FIG. 3, allowing power to flow only one way from the induction receiver coil 30 into the rechargeable battery 20. The protective circuitry may be directly connected to the contacts 22 thereby allowing power to flow from the induction receiver coil 30 into the rechargeable battery 20. Therefore, when the battery 20 comes into proximity with a charging induction coil (not shown) that may be plugged into a wall outlet or other power source, the induction receiver coil 30 may charge the battery 20.

The protective circuitry 32 may protect the induction receiver coil 30 from power that may be added to the battery 20 through another source, such as through a power cord connected with the electrical device, a contact charging base, or other source. The protective circuitry 32 may prevent electricity from flowing from the alternate charging source or from the battery itself into the induction receiver coil 30, thereby protecting the induction receiver coil 30. In an embodiment, the protective circuitry comprises a diode only allowing electricity to flow from the induction receiver coil 30 into the battery, but preventing electricity from flowing from another charging source or from the battery into the induction receiver coil 30. However, any protective circuitry may be utilized as apparent to one of ordinary skill in the art.

In an embodiment illustrated in FIG. 3, the induction receiver coil 30 and protective circuitry 32 may be disposed on a surface of the battery 20. The induction receiver coil 30 and protective circuitry 32 may be relatively flat and may not interfere with the fitting of the battery 20 into an electrical device. In an alternate embodiment illustrated in FIG. 4, a housing 34 (shown in cut-away view) may be disposed around the battery 20, the induction receiver coil 30, and/or the protective circuitry 32 to protect the same prior to disposing the battery 20 into the electrical device.

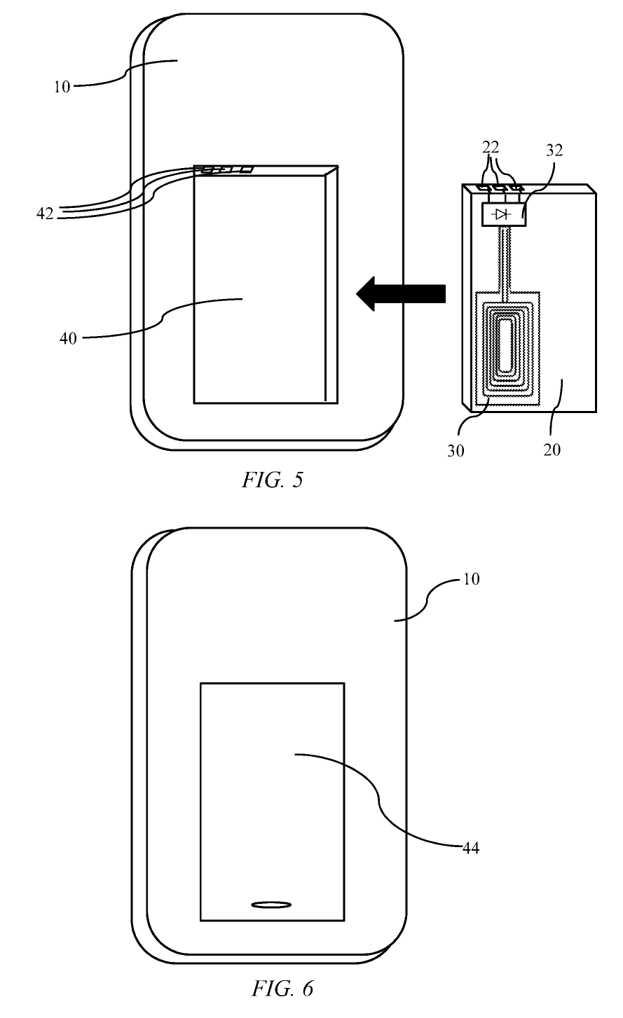

FIG. 5 illustrates the mobile smart phone 10 having a space or slot 40 for holding the battery comprising the induction receiver coil 30 and the protective circuitry 32. Contacts 42 within the space 40 may align with the contacts 22 of the battery 20, but may also be connected to the induction receiver coil 30, as described above. After disposing within the space 40 or slot 40, a cover 44 may be disposed thereon protecting the battery 20 and the induction receiver coil 30 with the protective circuitry 32.

Thus, an electrical device manufactured to not having induction charging capability may be converted into one that has induction charging capability, merely by changing the battery contained therein or merely by adding the induction receiver coil 30 and protective circuitry 32 to an existing rechargeable battery. The induction receiver coil may further be protected by being placed, with the battery, within the electrical device and covered or otherwise sealed therein. Further, because the induction receiver coil has protective circuitry that allows electricity to flow only one way, from the induction receiver coil into the battery, the electrical device may be charged as usual, via a charging cord or plug or through contact with a charging base, and via induction charging. Therefore, the addition of the induction receiver coil does not prevent the battery from being charged in its normal manner. Alternatively, because the battery can be charged inductively without plugging into an external power source, the battery may be completely sealed within the electrical device, providing an ability to use the electrical device in harsh environments, such as underwater or in dirty environments.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A rechargeable battery for an electrical device comprising:
a housing for the battery, wherein the housing comprises contacts configured to supply power to an electrical device and to receive power from a power source for charging the battery;
an induction receiver coil electrically connected to the contacts for supplying power from an induction charging coil when disposed in proximity to the induction charging coil; and
a protective circuit disposed between the induction receiver coil and the contacts, wherein the protective circuit is configured to protect the induction receiver from electricity from the battery and from another power source.

2. The rechargeable battery of claim 1 wherein the protective circuit is configured to allow electricity to flow from the induction receiver coil to the contacts.

3. The rechargeable battery of claim 1 wherein the protective circuitry is configured to prevent electricity from flowing from the contacts to the induction receiver coil.

4. The rechargeable battery of claim 1 wherein the protective circuit is configured to allow electricity to flow from the induction receiver coil to the contacts and to prevent electricity from flowing from the contacts to the induction receiver coil.

5. The rechargeable battery of claim 1 wherein the rechargeable battery further comprises: a protective housing disposed around the battery and covering the induction receiver coil.

6. The rechargeable battery of claim 1 wherein the induction receiver coil is adhered to the surface of the battery.

7. The rechargeable battery of claim 1 wherein the induction receiver coil and the protective circuit are disposed flat against the surface of the battery and configured to not interfere with the battery when it is disposed within an electrical device.

8. An electrical device comprising the rechargeable battery of claim 1.

9. The electrical device of claim 8, wherein the electrical device is a mobile smart device.

10. The electrical device of claim 8 wherein the battery is disposed within a slot and covered with a removable cover.

11. The electrical device of claim 8 wherein the battery is disposed within a slot and sealed within the electrical device, and further configured to be sealed from environmental contaminants.

12. A method of making a rechargeable battery induction system comprising the steps of:
providing a rechargeable battery configured to power an electrical device, wherein the rechargeable battery comprises contacts configured to power the electrical device and to receive electricity for charging thereof;
providing an induction receiver coil with protective circuitry;
electrically connecting the induction receiver coil to the contacts of the rechargeable battery such that the protective circuitry is positioned between the induction receiver coil and the contacts of the battery, wherein the protective circuitry is configured to allow electricity to flow from the induction receiver coil to the contacts of the battery and to further prevent electricity from flowing from the contacts of the battery to the induction receiver coil.

13. The method of claim 12 further comprising the step of:
inserting the rechargeable battery, the induction receiver coil and the protective circuitry into an electrical device to power the same.

14. The method of claim 12 further comprising the step of:
adhering the induction receiver coil onto a surface of the battery.

15. The method of claim 12 further comprising the step of:
adhering the induction receiving coil and the protective circuitry onto a surface of the battery.

16. The method of claim 12 further comprising the step of:
covering the battery, the induction receiver coil, and the protective circuitry with a protective cover.

17. The method of claim 12 further comprising the steps of:
installing the rechargeable battery with the induction receiver coil and the protective circuitry into an electrical device; and
charging the rechargeable battery by placing the electrical device in proximity to an induction charging coil.

18. The method of claim 17 further comprising the step of:
charging the rechargeable battery by plugging the electrical device into a wall outlet, wherein the protective circuitry prevents electricity from flowing from the wall outlet into the induction receiver coil.

19. The method of claim 17 further comprising the step of:
removing the battery from the electrical device and placing the battery onto a charging base in electrical contact with the contacts of the battery, wherein the protective circuitry prevents electricity from flowing from the charging base into the induction receiver coil.

20. The method of claim 13 further comprising the step of:
sealing the battery within the electrical device so that the electrical device is configured to prevent environmental contamination of the battery when exposed to harsh environmental conditions.
